(19) United States
(12) Patent Application Publication
(10) Pub. No.: US 2012/0051179 A1
(43) Pub. Date: Mar. 1, 2012

(54) METHOD AND APPARATUS FOR TIME-DOMAIN REVERSE-TIME MIGRATION WITH SOURCE ESTIMATION

(75) Inventor: Changsoo SHIN, Seoul (KR)

(73) Assignee: SNU R&DB FOUNDATION, Seoul (KR)

(21) Appl. No.: 13/164,462

(22) Filed: Jun. 20, 2011

(30) Foreign Application Priority Data
Aug. 26, 2010 (KR) 10-2010-0082733

(51) Int. Cl. G01V 1/36

(52) U.S. Cl. 367/50

(57) ABSTRACT

Provided is seismic imaging, particularly, a time-domain reverse-time migration technique for generating a real subsurface image from modeling parameters calculated through waveform inversion, etc. A reverse-time migration apparatus according to an example includes a source estimator configured to estimate sources by obtaining transmission waveforms from data measured by a plurality of receivers, through waveform inversion, and a migration unit configured to receive information about the estimated sources, and to perform reverse-time migration in the time domain. The source estimator estimates sources, by solving first-order matrix equation including a Toeplitz matrix composed of autocorrelation values of the Green's function, and a cross-correlation matrix of measured data and the Green's function, through Levinson Recursion. In more detail, the migration unit includes a back-propagation unit configured to back-propagate the measured data; a virtual source estimator configured to estimate virtual sources from the sources estimated by the source estimator; and a convolution unit that configured to convolve the back-propagated data with the virtual sources and output the results of the convolution.

### CROSS-REFERENCE TO RELATED APPLICATION

This application claims the benefit under 35 U.S.C. §119(a) of a Korean Patent Application No. 10-2010-0082733, filed on Aug. 26, 2010, the entire disclosure of which is incorporated herein by reference for all purposes.

### BACKGROUND

1. Field

The following description relates to a seismic imaging method, and more particularly, to a reverse-time migration for generating a real subsurface image from modeling parameters calculated by waveform inversion, etc.

2. Description of the Related Art

A two-way migration method requires significantly more computational resources than a one-way migration method. However, since the two-way migration method has substantially no dip limitation as well as processing multiarrivals, the two-way migration method allows seismic imaging regardless of the inclination of a reflection surface and also can preserve the real amplitudes of seismic wavefields. For these reasons, the two-way migration method has been widely utilized with the rapid growth of computing technology.

Reverse-time migration is performed by back-propagating field data, that is, measured data. Tarantola showed that reverse-time migration is tantamount to performing the first iteration of full waveform inversion (Tarantola, A., 1984, Inversion of Seismic Reflection Data in the Acoustic Approximation: Geophysics, 49, 1259-1266). Accordingly, as disclosed in papers “An Optimal True-amplitude Least-squares Prestack Depth-migration Operator: Geophysics, 64(2), 508-515” (Chavent, G., and R.-E. Plessix, 1999) and “Evaluation of Poststack Migration in Terms of Virtual Source and Partial Derivative Wavefields: Journal of Seismic Exploration, 12, 17-37” (Shin, C., D.-J.Min, D. Yang and S.-K.Lee, 2003), reverse-time migration shares the same algorithm as waveform inversion. Waveform inversion is accomplished by back-propagating the residuals between measured data and initial model responses, whereas reverse-time migration back-propagates field data.

Various sources were used in seismic exploration, but it was not easy to accurately detect the waveforms of a source since there are non-linear wave propagation, noise near the source and coupling between the source and receivers, etc. Existing reverse-time migration has been performed under an assumption that a source such as a Ricker wavelet is a true source. Accordingly, the existing reverse-time migration failed to reflect an accurate source, which became a factor limiting the resolution of reverse-time migration.

### SUMMARY

The following description relates to a technique for improving the resolution of reverse-time migration through source estimation in the time domain.

In one general aspect, there is provided a time-domain reverse-time migration apparatus including: a source estimator configured to estimate sources, by obtaining transmission waveforms from data measured by a plurality of receivers, through waveform inversion; and a migration unit configured to receive information about the estimated sources, and to perform reverse-time migration in the time domain.

The source estimator estimates the sources, by solving first-order matrix equation including a Toeplitz matrix composed of autocorrelation values of the Green's function, and a cross-correlation matrix of measured data and the Green's function, through Levinson Recursion.

The migration unit includes: a back-propagation unit configured to back-propagate the measured data; a virtual source estimator configured to estimate virtual sources from the sources estimated by the source estimator; and a convolution unit that configured to convolve the back-propagated data with the virtual sources and output the results of the convolution.

A reverse-time migration method according to an example was applied to a BP model (Billette and Brandsberg-Dhal, 2005). In this case, the length of a velocity model was 67 km, and the depth of the velocity model was 12 km. Also, a main frequency of 27 Hz was used, and a maximum available frequency was 54 Hz. Upon subsurface exploration, the number of sources was 1,348 and the number of receivers was 1,201.

In order to obtain virtual sources, time-domain modeling was performed on 2D sonic medium using an eighth-order finite-difference method. At this time, the grid interval having the length of 12.5 m and the depth of 6.25 m was used to be suitable for the velocity model. Also, a Ricker waveform was used as a transmission waveform and a transmission waveform inversion algorithm were used.

Comparing final images obtained when the Ricker waveform is used with final images obtained when a transmission waveform subject to waveform inversion is used, it has been proven that the final images obtained when the transmission waveform subject to waveform inversion is used show significantly clearer reflection surfaces. Particularly, the subsurface profile of a halite structure appeared significantly clearer from the final images obtained when the transmission waveform inversion algorithm is used.

Other features and aspects will be apparent from the following detailed description, the drawings, and the claims.

### BRIEF DESCRIPTION OF THE DRAWINGS

FIG. 1 is a diagram illustrating an example of a reverse-time migration apparatus.

FIG. 2 is a flowchart illustrating an example of a reverse-time migration method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

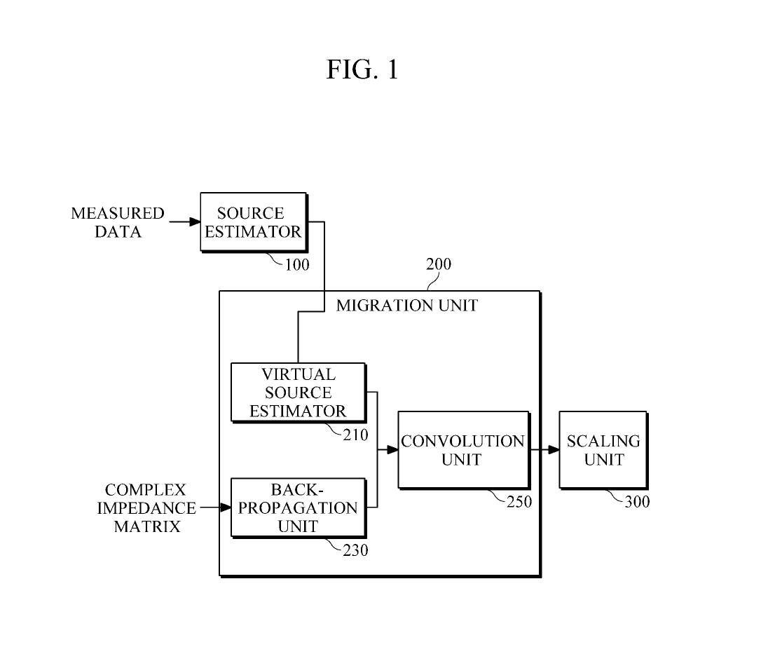

FIG. 1 is a diagram illustrating an example of a reverse-time migration apparatus. Referring to FIG. 1, the reverse-time migration apparatus includes a source estimator 100 that obtains transmission waveforms from measured data on receivers to estimate sources, and a migration unit 200 that receives information about the estimated sources to perform reverse-time migration in the time domain.

According to an example, the migration unit 200 includes a back-propagation unit 230 that back-propagates the measured data on the receivers, a virtual source estimator 210 that estimates virtual sources from the sources estimated by the source estimator 100, and a convolution unit 250 that convolves the back-propagated data with the virtual sources and outputs the convolved data.

As mentioned in the paper “Evaluation of Poststack Migration in Terms of Virtual Source and Partial Derivative Wavefields: Journal of Seismic Exploration, 12, 17-37” (Shin, C., D.-J. Min, D. Yang and S.-K. Lee, 2003), migration can generally be expressed as a zero-lag cross-correlation between the partial derivative wavefields with respect to an earth parameter (such as velocity, density or impedance) and the measured data on the receivers in the time domain, as follows.

$${φ}_{k} = {\sum }_{s = 1}^{nshot} {\int }_{0}^{{T}_{max}} {[ \frac{\partial {u}_{s} ( t )}{\partial {m}_{k}} ]}^{T} {d}_{s} ( t ) d t \qquad ( 1 )$$

where Φₖ denotes the 2D migration image for the k-th model parameter, Tₘₐₓ is the maximum record length,

$$\frac{\partial {u}_{s} ( t )}{\partial {m}_{k}} \qquad$$

is the partial derivative wavefield vector, dₛ(t) is the field data vector, and s indicates the shot number.

In order to easily describe reverse-time migration equation, migration in the frequency domain will be described. In the frequency domain, migration can be expressed using the Fourier transform pairs (Brigham, E. O., 1988, the Fast Fourier Transform and its Applications: Avantek, Inc., Prentice Hall.) as:

$${φ}_{k} = {\sum }_{s = 1}^{nshot} {\int }_{0}^{{ω}_{max}} Re \{ {[ \frac{\partial {\tilde{u}}_{s} ( ω )}{\partial {m}_{k}} ]}^{T} {\tilde{d}}_{s}^{*} ( ω ) \} d ω \qquad ( 2 )$$

where ω is the angular frequency, ũₛ and \tilde{d}ₛ are the frequency-domain modeled and field data vectors, the superscript * denotes the complex conjugate, and Re indicates the real part of a complex value.

In waveform inversion, an objective function can be written as:

$$E = \frac{1}{2} {\sum }_{s = 1}^{nshot} {\int }_{0}^{{ω}_{max}} {{[ {\tilde{u}}_{s} ( ω ) - {\tilde{d}}_{s} ( ω ) ]}^{T} [ {\tilde{u}}_{s} ( ω ) - {\tilde{d}}_{s} ( ω ) ]}^{*} d ω , \qquad ( 3 )$$

where the superscript T represents the transpose of the vector and (ũₛ- \tilde{d}ₛ) is the residual vector between modeled and field data. The gradient is obtained by taking the partial derivative of the objective function with respect to the model parameter, which yields:

$$\frac{\partial E}{\partial {m}_{k}} = {\sum }_{s = 1}^{nshot} {\int }_{0}^{{ω}_{i}} Re \{ {( \frac{\partial {\tilde{u}}_{s}}{\partial {m}_{k}} )}^{T} {( {\tilde{u}}_{s} - {\tilde{d}}_{s} )}^{*} \} d ω , \qquad ( 4 )$$

It is seen that equation 2 has the same form as equation 4, which means that the reverse-time migration corresponds to the gradient in waveform inversion.

To obtain the migration image or gradient, the partial derivative wavefields in equation 2 have to be computed, which can be obtained by using a forward-modeling algorithm (Shin, C., S. Pyun, and J. B. Bednar, 2007, Comparison of Waveform Inversion, Part 1: Conventional Waveform vs. Logarithmic Wavefield: Geophys. Prosp., 55, 449-464). Frequency-domain wave modeling can be expressed in matrix form (Martha, K. J., 1984, Accuracy of Finite-difference and Finite-element Modeling of the Scalar and Elastic Wave Equation: Geophysics, 49, 533-549) as:

Sũₛ=f (5)

and

S=K+iωC+ω²M (6)

where f is the source vector, S is the complex impedance matrix originating from the finite-element or finite-difference methods, and K C , and M are the stiffness, damping, and mass matrices, respectively. When the derivative of equation 5 with respect to the model parameter mₖ is taken, the partial derivative wavefields (Pratt, R. G., C. Shin, and G. J. Hicks, 1998, Gauss-Newton and Full Newton Methods in Frequency Domain Seismic Waveform Inversions: Geophys. J. Int., 133, 341-362) can be obtained as follows:

$$S \frac{\partial {\tilde{u}}_{s}}{\partial {m}_{k}} + \frac{\partial S}{\partial {m}_{k}} {\tilde{u}}_{s} = 0 , \qquad ( 7 )$$

where fᵥ is the virtual source vector expressed by

$${f}_{v} = - \frac{\partial S}{\partial {m}_{k}} {\tilde{u}}_{s} .$$

First-order wave equation in the time domain is expressed as finite-difference equation below:

$$\frac{1}{{m}_{i}^{2}} \frac{{u}_{i}^{k + 1} - 2 {u}_{i}^{k} + {u}_{i}^{k - 1}}{Δ {t}^{2}} = \frac{{u}_{i + 1}^{k} - 2 {u}_{i}^{k} + {u}_{i - 1}^{k}}{Δ {x}^{2}} + {f}_{i}^{k} , \qquad ( 8 )$$

where mᵢ is velocity of i-th medium, Δt is the time interval, Δx is the grid interval, k is the current time step, and ƒᵢ^{k} represents the source.

Equation 8 can be expressed in matrix form as:

$$[ \begin{matrix}\frac{2}{Δ {x}^{2}} + \frac{1}{{v}_{1}^{2}} \frac{{\partial }^{2}}{\partial {t}^{2}} & - \frac{1}{Δ {x}^{2}} & 0 & … & 0 \\ - \frac{1}{Δ {x}^{2}} & \frac{2}{Δ {x}^{2}} + \frac{1}{{v}_{2}^{2}} \frac{{\partial }^{2}}{\partial {t}^{2}} & - \frac{1}{Δ {x}^{2}} & & ⋮ \\ 0 & & & ⋱ & 0 \\ ⋮ & & ⋱ & ⋱ & \\ 0 & 0 & & - \frac{1}{Δ {x}^{2}} & \frac{2}{Δ {x}^{2}} + \frac{1}{{v}_{nn}^{2}} \frac{{\partial }^{2}}{\partial {t}^{2}}\end{matrix} ] [ \begin{matrix}{u}_{1} \\ {u}_{2} \\ ⋮ \\ {u}_{nn}\end{matrix} ] = [ \begin{matrix}{f}_{1} \\ {f}_{2} \\ ⋮ \\ {f}_{nn}\end{matrix} ] \qquad ( 9 )$$

The above matrix equation 9, which represents time-domain wave equation, has the same form as equation 5. A virtual source for obtaining the partial derivative wavefield can be calculated as:

$$\frac{\partial S}{\partial {m}_{i}} u = \frac{- 2}{{m}_{i}^{3}} \frac{{\partial }^{2} u}{\partial {t}^{2}} \qquad ( 10 )$$

By putting equation 10 into the ƒv term of equation 7, the partial derivative wavefield in the time domain can be obtained.

Substituting equation 7 to equation 2 gives

$${φ}_{k} = {\sum }_{s = 1}^{nshot} {\int }_{0}^{{ω}_{max}} Re [ {{f}_{v}^{T} ( {S}^{T} )}^{- 1} {d}_{s}^{*} ] d ω \qquad ( 11 )$$

for the k-th model parameter. If all of the model parameters are considered, the virtual source vector is replaced with the virtual source matrix Fᵥ^{T}:

$$φ = {\sum }_{s = 1}^{nshot} {\int }_{0}^{{ω}_{max}} Re [ {{F}_{v}^{T} ( {S}^{T} )}^{- 1} {d}_{s}^{*} ] d ω \qquad ( 12 )$$

In equation 12, the combination (S^{T})⁻¹dₛ* of the second and third terms means the back-propagation of field data, because the complex impedance matrix S is symmetrical. By convolving the back-propagated field data with virtual sources, a reverse-time migration image may be obtained.

As illustrated in FIG. 1, the migration unit 200 obtains the reverse-time migration image by using the back-propagation unit 230 that back-propagates the measured data on the receivers, the virtual source estimator 210 that estimates virtual sources from the sources estimated by the source estimator 100, and the convolution unit 250 that convolves the back-propagated data with the virtual sources and outputs the convolved data. Back-propagation has been well-known in the seismic exploration technology.

The virtual source estimator 210 computes the virtual sources from forward-modeled data, for which a source wavelet has to be obtained. In general cases, the source wavelet has been assumed to be either a near-offset trace or a well-known function, such as a Ricker wavelet, or the first derivative of a Gauss function, because the exact source wavelet cannot be reproduced in either field exploration or seismic data processing. According to an example, if the source wavelet is estimated with de-convolution based on Levinson recursion, more reliable source wavelets can be employed in reverse-time migration, which may yield better images.

The convolution unit 250 multiplies the back-propagated data matrix by the virtual source matrix, which means convolution in the time domain.

According to an example, the source estimator 100 estimates sources, by solving first-order matrix equation including a Toeplitz matrix composed of autocorrelation values of the Green's function, and a cross-correlation matrix of measured data and the Green's function, through Levinson Recursion.

If background velocity is equal to real velocity, real field data can be expressed as convolution of modeling data with a real source waveform, like equation 13:

$$\begin{matrix}d ( {\vec{x}}_{s} , {\vec{x}}_{r} , t ) = g ( {\vec{x}}_{s} , {\vec{x}}_{r} , t ) * s ( t ) \\ = {\sum }_{τ} g ( {\vec{x}}_{s} , {\vec{x}}_{r} , τ ) \cdot s ( t - τ ) ,\end{matrix} \qquad ( 13 )$$

where \vec{xₛ} represents the location of a transmission source, \vec{x^{r}} represents the location of a receiver, d represents the real field data, g is the Green function, and s(t) represents the source s waveform. If s(t) is considered as an optimum Wiener filter coefficient, de-convolution can be easily performed using Levinson recursion. The least-square error (L) for using the de-convolution can be defined as follows:

$$L = {\sum }_{t} {( d ( {\vec{x}}_{s} , {\vec{x}}_{r} , t ) - {\sum }_{τ} g ( {\vec{x}}_{s} , {\vec{x}}_{r} , t ) * s ( t - τ ) )}^{2} \qquad ( 14 )$$

In order to obtain s(t)={s₁, s₂, . . . , sᵢ, . . . , sₙ} having the minimum least-square error (L), s(t) whose partial derivative with respect to s, of the L value is zero for each time step has to be obtained.

$$\frac{\partial L}{\partial {s}_{i}} = - 2 {\sum }_{t} d ( {\vec{x}}_{s} , {\vec{x}}_{r} , t ) \cdot g ( {\vec{x}}_{s} , {\vec{x}}_{r} , t - i ) + 2 {\sum }_{t} ( {\sum }_{τ} s ( τ ) \cdot g ( {\vec{x}}_{s} , {\vec{x}}_{r} , t - τ ) ) \cdot g ( {\vec{x}}_{s} , {\vec{x}}_{r} , t - i ) = 0 \\ {\sum }_{τ} [ s ( τ ) \cdot ( {\sum }_{t} g ( {\vec{x}}_{s} , {\vec{x}}_{r} , t - τ ) \cdot g ( {\vec{x}}_{s} , {\vec{x}}_{r} , t - i ) ) ] = {\sum }_{t} d ( {\vec{x}}_{s} , {\vec{x}}_{r} , t ) \cdot g ( {\vec{x}}_{s} , {\vec{x}}_{r} , t - i ) \qquad ( 15 )$$

The right side of equation 15 is composed of a correlation between the real field data and the Green's function, and the left side of equation 15 is composed of a production of an autocorrelation of the Green's function with the source waveform. If equation 15 is applied to all time steps, equation 16 can be obtained.

$$\begin{matrix}( \begin{matrix}{r}_{0} & {r}_{1} & {r}_{2} & … & {r}_{n - 1} \\ {r}_{1} & {r}_{0} & {r}_{1} & … & {r}_{n - 2} \\ ⋮ & ⋮ & ⋮ & ⋱ & ⋮ \\ {r}_{n - 1} & {r}_{n - 2} & {r}_{n - 3} & … & {r}_{0}\end{matrix} ) ( \begin{matrix}{s}_{0} \\ {s}_{1} \\ ⋮ \\ {s}_{n - 1}\end{matrix} ) = ( \begin{matrix}{h}_{0} \\ {h}_{1} \\ ⋮ \\ {h}_{n - 1}\end{matrix} ) , \\ where & ( 16 ) \\ {\sum }_{t} g ( {\vec{x}}_{s} , {\vec{x}}_{r} , t - τ ) \cdot g ( {\vec{x}}_{s} , {\vec{x}}_{r} , t - i ) = r ( {\vec{x}}_{s} , {\vec{x}}_{r} , i - τ ) = {r}_{i - τ} \\ {\sum }_{t} d ( {\vec{x}}_{s} , {\vec{x}}_{r} , t ) \cdot g ( {\vec{x}}_{s} , {\vec{x}}_{r} , t - i ) = h ( {\vec{x}}_{s} , {\vec{x}}_{r} , i ) = {h}_{i} . & ( 17 )\end{matrix}$$

Since the autocorrelation matrix of equation 16 is a Toeplitz matrix, the transmission waveform (sᵢ, i=0,1, 2, . . . , (n−1)) can be quickly obtained using the Levinson recursion.

According to another example, the time-domain reverse-time migration apparatus further includes a scaling unit 300 that scales the migrated image using the diagonal of the pseudo-Hessian matrix. As disclosed in the paper “Improved Amplitude Preservation for Prestack Depth Migration by Inverse Scattering Theory: Geophys. Prosp., 49, 592-606” (Shin, C., S. Jang and D.-J. Min, 2001), a reverse-time migration image can be enhanced by scaling the migrated image using the diagonal of the pseudo-Hessian matrix. By applying the scaling method to equation 12, the migration image can be rewritten as:

$$φ = \frac{{\int }_{0}^{{ω}_{max}} Re [ {{F}_{v}^{T} ( {S}^{T} )}^{- 1} {d}_{s}^{*} ] d ω}{{\int }_{0}^{{ω}_{max}} Re [ diag ( {( {F}_{v} )}^{* T} {F}_{v} ) ] d ω + λ} , \qquad ( 18 )$$

where diag [(Fᵥ*^{T}Fᵥ] indicates the diagonal of the pseudo-Hessian matrix, and t is the damping factor.

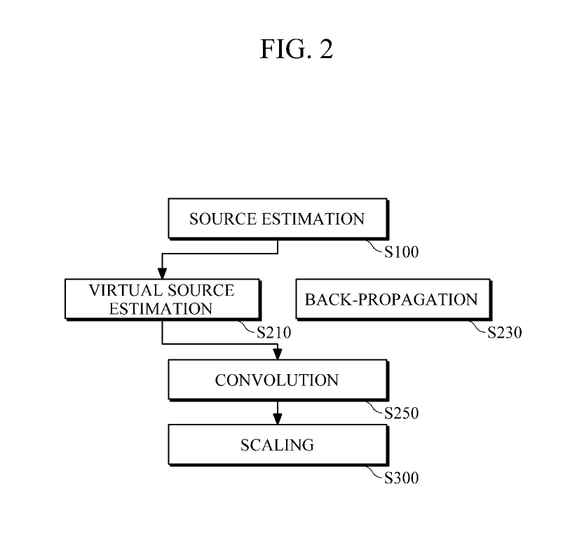

FIG. 2 is a flowchart illustrating an example of a reverse-time migration method, As illustrated in FIG. 2, the reverse-time migration method includes source estimation operation (S100) of estimating sources from measured data on receivers; and migration operation (S210, S230, S250) of receiving information about the estimated sources and performing reverse-time migration in the time domain.

According to an example, the sources are estimated by solving first-order matrix equation including a Toeplitz matrix composed of autocorrelation values of the Green's function, and a cross-correlation matrix of measured data and the Green's function, through Levinson Recursion. This corresponds to a process of solving the first-order matrix equation 16 whose coefficients are defined by equation 15.

According to an example, the migration operation includes back-propagation operation (S230) of back-propagating measured data to estimate sources, virtual source estimation operation (S210) of estimating virtual sources from the estimated sources, and convolution operation (S250) of convolving the back-propagated data with the virtual sources and outputting the convolved data.

The back-propagation operation (S230) is to calculate (S^{T})⁻¹dₛ* of equation 12 using a back-propagation method. The virtual source estimation operation (S210) is expressed by equation 11, to calculate a matrix Fᵥ of equation 10 by iterating a virtual source defined by

$${f}_{v} = - \frac{\partial S}{\partial {m}_{k}} {\tilde{u}}_{s}$$

with respect to all model parameters. (->to drafter: please check it) In order to obtain the virtual sources, forward-modeled data is required and an estimated source wavelet is required for obtaining the forward-modeled data. The convolution operation (S250) is to multiply the results obtained by equation 17 in the back-propagation operation (S230) by the matrix Fᵥ^{T}, that is, to convolve the results obtained in the back-propagation operation (S230) in the time domain.

According to an example, the reverse-time migration method further includes scaling operation (S300) of scaling the migrated image obtained in the migration operation (S210, S230, S250) using the diagonal of the pseudo-Hessian matrix. The scaling operation (S300) is to divide the real part of the result obtained in the migration operation (S210, S230, S250) by the real part of the diag[(Fᵥ)*^{T}Fᵥ] term.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A time-domain reverse-time migration apparatus comprising:
a source estimator configured to estimate sources by obtaining transmission waveforms from data measured by a plurality of receivers through waveform inversion; and
a migration unit configured to receive information about the estimated sources, and to perform reverse-time migration in the time domain.

2. The time-domain reverse-time migration apparatus of claim 1, wherein the source estimator estimates the sources by solving first-order matrix equation including a Toeplitz matrix composed of autocorrelation values of the Green's function and a cross-correlation matrix of measured data and the Green's function through Levinson Recursion.

3. The time-domain reverse-time migration apparatus of claim 1, wherein the migration unit comprises:
a back-propagation unit configured to back-propagate the measured data;
a virtual source estimator configured to estimate virtual sources from the sources estimated by the source estimator; and
a convolution unit that configured to convolve the back-propagated data with the virtual sources and output the results of the convolution.

4. The time-domain reverse-time migration apparatus of claim 3, further comprising a scaling unit configured to scale a migration image output from the migration unit using a diagonal term of a pseudo-Hessian matrix.

5. A time-domain reverse-time migration method comprising:
estimating sources by obtaining transmission waveforms from data measured by a plurality of receivers through waveform inversion; and
receiving information about the estimated sources, and performing reverse-time migration in the time domain.

6. The time-domain reverse-time migration method of claim 5, wherein the estimating of the sources comprises estimating the sources, by solving first-order matrix equation including a Toeplitz matrix composed of autocorrelation values of the Green's function and a cross-correlation matrix of measured data and the Green's function through Levinson Recursion.

7. The time-domain reverse-time migration method of claim 5, wherein the performing of the reverse-time migration comprises:
back-propagating the measured data;
estimating virtual sources from the sources estimated by the source estimator; and
convolving the back-propagated data with the virtual sources and outputting the results of the convolution.

8. The time-domain reverse-time migration method of claim 5, further comprising scaling a migration image calculated in the performing of the reverse-time migration, using a diagonal term of a pseudo-Hessian matrix.

9. The time-domain reverse-time migration apparatus of claim 2, wherein the migration unit comprises:
a back-propagation unit configured to back-propagate the measured data;
a virtual source estimator configured to estimate virtual sources from the sources estimated by the source estimator; and
a convolution unit that configured to convolve the back-propagated data with the virtual sources and output the results of the convolution.

10. The time-domain reverse-time migration apparatus of claim 9, further comprising a scaling unit configured to scale a migration image output from the migration unit using a diagonal term of a pseudo-Hessian matrix.

11. The time-domain reverse-time migration method of claim 6, wherein the performing of the reverse-time migration comprises:
back-propagating the measured data;
estimating virtual sources from the sources estimated by the source estimator; and
convolving the back-propagated data with the virtual sources and outputting the results of the convolution.
